(19) United States
(12) Patent Application Publication
(10) Pub. No.: US 2003/0001439 A1
(43) Pub. Date: Jan. 2, 2003

(54) Magnetohydrodynamic EMF generator

(76) Inventor: Henry B. Schur, Hallandale, FL (US)

Correspondence Address: Robert J. Van Der Wall, First Union Financial Center, Suite 5100, 200 South Biscayne Boulevard, Miami, FL, 33131-2310, US

(21) Appl. No.: 10/184,691

(22) Filed: Jun. 28, 2002

Related U.S. Application Data
(60) Provisional application No. 60/302,307, filed on Jul. 2, 2001.

(51) Int. Cl. G21D 7/02; H02K 44/00

(52) U.S. Cl. 310/11

(57) ABSTRACT

A new and novel method and apparatus to treat flowing fluid is disclosed. Electrical energy (EMF) is produced by the flow of a magnetically charged fluid through an inductor. The device produces a magnetic field upstream of the inductor/pick up coil through which a magnetizable fluid is passed. The fluid is imparted with a magnetic energy field as it flows through the chamber containing the magnetic field generator and hence through a coil of conductive wire wherein an induced electrical current is generated. The induced EMF generated is then fed back into the fluid stream through an electrode arrangement whereby the electricity produces an electrolysis of the fluid releasing gases at the specific electrode. The gases produced are carried by the fluid to the application point. The device can be used to condition and enhance any hydrocarbon based fuel to give better combustion efficiency and reduce emissions. Additionally, the device acts as a fuel conditioner to reduce algae and bacterial contamination in re-circulating fuel systems. Further, the same principles can be applied to other fluids such as water, which will reduce both scaling and the biological load of the fluid.

### CROSS REFERENCE TO OTHER APPLICATIONS

This application claims the benefit of provisional application Serial No. 60/302,307 filed Jul. 2, 2001. This application is copending therewith and claims the filing date thereof as to the common subject matter.

### BACKGROUND OF THE INVENTION

1. Field of the Invention

This field of this invention relates to an apparatus and method for the treatment of fluids such as hydrocarbon fuels and other fluids such as water. The invention contemplates the use of magnetically treated moving fluids to generate by means of magnetohydrodynamics (MHD) an electromotive force (EMF) current which current is then used to generate gases in the same moving fluid stream. The gases are produced by the EMF current powered electrolysis of some of the fluid. When the fluid is a hydrocarbon fuel, the electrolysis takes place in regard to the fuel and/or water present in the fuel, which releases hydrogen and oxygen gas. These gases remain dissolved and/or suspended in the fuel stream and result in (1) an increase the combustion efficiency of the fuel and (2) a reduction in the emission of toxic exhaust gases. The fuel can be used in association with either internal combustion engines, or external combustion systems, such as a furnace or a jet engine. Another aspect of this invention is the use of the same combination of magnetic treatment of a fluid, generation of an EMF current, and the use of the EMF current to cause electrolysis can be used with fluids other than hydrocarbon fuels, such as water, to reduce bio fouling and scaling. This achieved because the magnetic treatment causes reduction in scaling, and the formation of gases by electrolysis, at least the oxygen, reduces the biological load of the fluid.

2. Description of the Prior Art

The magnetic and other treatments of hydrocarbon fuels to impart beneficial results in the combustion of these fuels has been widely noted and many devices are currently in use. Examples of these devices are shown in following recitation of prior art.

A principal reference is Butt, U.S. Pat. No. 6,024,073 issued Feb. 15, 2000 for hydrocarbon fuel modification device and a method for improving the combustion characteristics of hydrocarbon fuels. It comprises a casing having an inlet fitting, an outlet fitting and a flow axis between the inlet fitting and the outlet fitting. The casing encloses a plurality of catalytic pellets held in layers by at least two spaced-apart Monel screens positioned perpendicularly relative to the flow axis. The casing also encloses at least one magnet positioned adjacent to and without touching, one of the Monel screens. The magnet contains at least one element from a group of elements comprising strontium and barium. The catalytic pellets comprises the following composition percentages by weight: 2-7% bismuth; 3-7% mercury; 70-80% tin; and 15-25% antimony. There is further provided a method for treating hydrocarbon fuel within the device wherein an electrolytic action is caused to occur between the fuel and the magnet for causing some of the oxygen molecules in the water impurities to separate from the fuel impurities and to bond to the hydrocarbon molecules as oxygenates. There is also provided a method for freeing radicals of hydrogen from the water impurities and for causing some of the radicals of hydrogen to join hydrocarbon chains within the fuel for forming new and shorter hydrocarbon chains. Butt teaches the improvement of fuel by reconstructing the hydrogen and oxygen into the gaseous state but does not anticipate or suggest the use of magnetohydrodynamics (MHD) to generate an electric current for said purpose. Additionally no teachings related to the process of electrolysis is anticipated or suggested as the deconstructing method. An obvious improvement over Butt is the elimination of the “catalyst” which contains both expensive and toxic materials.

Another reference is U.S. Pat. No. 5,003,517 by Greer, Jr., issued Mar. 26, 1991 for a MHD fluid apparatus and method. It teaches a transducer of great sensitivity which incorporates a MHD cell exposed to the flow of a electrically conductive fluid within a channel. Flexible diaphragms form the ends of the channel and deflect with the fluid motion. The deflection is sensed by strain gauges and the signals from the MHD cell and strain gauges are processed. In addition, an MHD power generator is contemplated which generates power from a moving electrically conductive fluid, such as sea water in geophysical motion. A strong magnetic field is established normal to the direction of fluid flow. Electrodes are positioned normal to both the magnetic field and fluid flow to complete a circuit to transfer the power generated by the movement of the electrically conductive fluid through the magnetic field. However, Greer, Jr. does not teach the use of MHD in a closed loop system to impart additional properties to the fluid.

An additional reference is U.S. Pat. No. 5,136,173 by Rynne issued Aug. 4, 1992, for an ocean wave energy conversion system. It teaches a float adapted to ride on the surface of the ocean in reciprocal vertical motion in response to ocean wave front action, first support means extending downward from the float deeper into the ocean and, MHD electric generator means mounted to the first means at a level of attenuated vertical wave action in the ocean, the generator comprising a duct arranged to channel the flow of sea water vertically therethrough in response to the reciprocal vertical motion of the float, second means including magnetic field elements for applying a strong magnetic field cross-wise to the longitudinal axis of the duct and the flow of sea water therethrough, electrode means positioned in the duct and in contact with the flowing sea water therethrough such that the electrode means receives electrical energy generated by MHD phenomenon as the sea water passes upwardly and downwardly in a relative manner through the magnetic field, and transfer means connected to the electrode for conveying the generated electrical energy outward from the MHD electric means generator to an external electric load.

This reference only teaches the use of MHD generation to produce an electric current and not the integration of the emf generation back into the system. Rynne does not teach the use of a flow through system as he only describes a reciprocal motion, vertical motion within an open tube chamber and does not anticipate or suggest a closed flow design.

A further reference is Hayes, U.S. Pat. No. 5,633,541 issued May 27, 1997 for a MHD electric generator. Disclosed is a generator which is so devised that the coherent light generated in it by electrical stimulation, heat induction and/or gas expansion is collected and focused towards the gas plasma moving between magnets and electricity-collecting plates. In this generator, the composition of the laser gas mixture is also controlled and adjusted to compensate for the unavoidable loss occurring in operation, when some of the gas molecules, especially CO₂, are dissociated. In this reference, EMF is generated by use of laser technology and is for the production of electricity only with no art relating to re-inserting the generated current back into the generating fluid to gain other properties.

The next reference is Twardzik, U.S. Pat. No. 5,558,765, which issued Sep. 24, 1996. It teaches an apparatus for subjecting hydrocarbon-based fuels to intensified magnetic fields for increasing fuel burning efficiency. The specifics include means for the intensified exposure of a hydrocarbon based fuel to a magnetic field comprising at least two permanent magnets having opposite faces polarized north and south, a cover box for containing each of said magnets made from non-magnetic material for containing said magnets and having a bottom opening and a peripheral depending flange having curved hollows for fitting closely about a fluid containment vessel, a backing plate for closing said bottom opening made from non-magnetic material and being recessed inward to permit the close fit of the fluid containment vessel within said curved hollows, and strapping means for securing said cover boxes in fixed diametrically opposed position about said fluid containment vessel for creating an electromagnetic circuit having an enhanced, substantially uniform, mono-directional, magnetic flux density for the polarization of the molecules of said fuel to increase the combustion efficiency of said fuel. But Twardzik does not teach direct contact treatment of the fuel nor does it include any art relating to MHD and fuel treatment.

Another reference is U.S. Pat. No. 5,566,661 by Zorita issued Oct. 22, 1996 for fuel economizers, applicable to gas-oil and gasoline engines and burners. It discloses a magnetic housing, that is coupled to a fuel consumption pipe in a gas or gas-oil combustion engine. The magnetic housing comprises a pair of magnets, a magnetic receiver and a magnetic transmitter, for producing magnetic fields on fuel flowing through the coupled pipe to reduce the fuel consumption rate. The housing comprises a main body having a cylindrical shaped bottom portion with a cylindrical recess for supporting an exposed cylindrical magnetic receiver and a top portion having a pair of winged vertical projections, curved at the same degree as the cylindrical bottom portion. Each projection has inner helicoidal threading and each positioned to allow the pipe to rest therebetween on the exposed magnet. The housing also comprises a complementary body having a cylindrical shape with a cylindrical recess at its bottom for supporting an exposed magnetic transmitter. The complementary body has an outer helicoidal threading acceptable into the inner threading of the projections upon rotation to secure the pipe between the exposed magnets of the main and complementary bodies. However, Zorita lacks any teachings on the direct contact of the fluid with the magnetizing field and on a feedback loop and/or of any MHD technology.

The next reference is Adam, et al., U.S. Pat. No. 5,637,226 issued Jun. 10, 1997 for magnetic fluid treatment. A fluid is circulated through a region of single magnetic polarity within a complex magnetic field and with increased exposure time as compared to prior art devices. The fluid travels through a coil of tubing arranged between two magnetic fields that interact to form the region of single polarity. In a preferred embodiment, the fields are generated by two sets of magnets, one on the inside of the coil and one on the outside of the coil. The magnets are arranged such that like poles of all the magnets face the tubing in the coil, creating the region of single polarity. Treating fuel or recirculated exhaust gases prior to burning in internal combustion engines results in allegedly improved engine output characteristics. But in Adam, there is lacking any art or teachings relating to the use of electrolysis of the fluid to produce or add properties or of the use of MHD to generate the current necessary for such. No laminar flow fluid properties anticipated to increase efficiency of magnetization.

An additional reference is U.S. Pat. No. 6,054,049 by Hamasaki, et al., issued Apr. 25, 2000 for a magnetic fluid modification device and its use. It teaches that to improve the affinity between a gas and a liquid, the liquid is passed through an enclosure where it contacts a portion of the magnets of a magnetic field generating device and passes through the magnetic field created by the magnets while a gas is in contact with the other portion of the magnets. A liquid level control device maintains and controls the liquid level so that the magnets simultaneously extend about equally into the gas and liquid with both contacting the magnets and being within the magnetic field created by the magnets. The gas in the enclosure increases the effectiveness that the magnetic field and magnets have on the liquid. The gas used in the enclosure can optionally subsequently be mixed with the liquid or another gas can be mixed with the liquid. Additional gases and liquids can be mixed together. The device and process associated with it can be used on different liquids and different gases, including fuel mixed with air in a combustion process. However, Hamasaki does not teach that the gas can be generated within the fuel itself, no MHD concepts are taught, and there is no feedback loop circuit.

A further reference is U.S. Pat. No. 6,178,954 to Kim and dated Jan. 30, 2001 for a device for reducing toxic wastes of diesel fuel. It teaches a pre-treatment device mounted to the surface side of a fuel feed port at a diesel internal combustion engine so as to activate molecules in diesel fuel and their molecular movement. In particular, with a view to effective induction of electromagnetic waves and magnetic fields, supplemental equipment includes such things as a magnet, ceramic pole and coil arranged on the device of this invention. Based on this, the reference asserts perfect combustion conditions of diesel fuel may be provided-in such a manner that some physicochemical changes are offered to diesel fuel, passing through the fuel feed port. Nonetheless, Kim does not teach the direct fuel contact with the magnetizing field, and there is no art on using MHD to treat fuel through self generated EMF.

The next reference is U.S. Pat. No. 6,386,187 to Phykitt just issued on May 14, 2002 for a device and process for improving fuel consumption and reducing emissions upon fuel combustion. It teaches treatment of a hydrocarbon or fossil fuel which is to be combusted in a combustion chamber to improve combustion by turbulently treating the fuel with a plurality of fields of magnetic flux and subjecting the fuel to a field of differing standard electrochemical reduction potentials. The device is adapted to be connected in-line in a fuel supply line of the combustion chamber and comprises a non-magnetic, elongate hollow tubular housing having a longitudinal axis, opposing inlet and outlet ends, an inlet aperture in said inlet end for receiving fuel and an outlet aperture in said outlet end for dispensing treated fuel, a plurality of longitudinally elongated magnets located in the housing on opposing sides of the longitudinal axis providing a series of differing or alternating fields of magnetic flux along the longitudinal axis and providing opposing, facing pole faces of the magnets for contact with the fuel, and optionally, but preferably, at least two large surface area non-ferrous metal wool or screen materials of differing standard electrochemical reduction potentials in the housing, the metals being located along the longitudinal axis of the housing and between the magnets of the plurality of magnets and establishing a field of standard electrochemical reduction potential differential in the housing through which the fuel must flow. The device may also comprise axially spaced, radially extending, apertured flow controllers for directly turbulent flow of fuel through the screen materials and the series of alternating field of magnetic flux. But Phykitt lacks art on use of MHD to improve fuel properties, and there is no art disclosed pertaining to the use of laminar flow within the system to aid in the magnetization process.

An additional reference U.S. Pat. No. 6,394,075 to Castaldini and just issued on May 28, 2002 for a device for treating fuel in internal combustion engines. It teaches, within a surrounding body which is insulating in relation to magnetic field, a through-pipe for supplying the fuel to the engine and a plurality of magnetic masses which create a magnetic field perpendicular to the direction of movement of the fuel inside its through-pipe. But Castaldini does not include art in regard to MHD or in using the magnetized fluid to be used in such a manner and no feedback loop concepts are taught.

A further reference is U.S. Pat. No. 5,992,398 to Ho dated Nov. 30, 1999 for a fuel saver device and process for using same. It teaches an improved fuel line insert including a cylindrical housing extending between oppositely disposed input and output ports, and constructed to include inner and outer chamber surfaces, such that an internal volume is realized in a form of an internal chamber extending between the input and output ports. At least two permanent magnets oppositely disposed from each other and mounted at each magnet's south pole into the inner chamber surface such that each magnets north poles face each other in the chamber in such an arrangement that fuel may flow between the two. The alleged improvement is asserted to lie in the strength of the material comprising the casing and the magnets which is a result of construction of same with a nickel/low carbon steel alloy. However, Ho does not teach use of flowing fuel to generate an EMF feedback current or that the fuel should be in direct contact with the magnetizing field.

Another reference is Fletcher, U.S. Pat. No. 5,882,514 issued Mar. 16, 1999 for apparatus for magnetically treating fluids. It teaches a magnetic cartridge arranged within a shell to define a fluid passage between the inlet and the outlet of the shell and having components for subjecting fluid in the passage to both turbulence and magnetic forces. The magnetic cartridge includes magnetic discs and may define either or both a central passage and an annular passage through the shell. The annular passage may be further defined by a spiral coil for accelerating the fluid, and the coil and the surface of the cartridge may be made of catalytic metals for enhancing the fuel treatment. This reference, however, does not teach a laminar flow fluid path or MHD generation.

An additional reference is U.S. Pat. No. 5,829,420 by Kita dated Nov. 3, 1998 for an electromagnetic device for the magnetic treatment of fuel. It teaches both a method and apparatus for the magnetic treatment of a hydrocarbon fuel in order to achieve stoichiometric combustion. One embodiment consists of an emission sensing means, a microprocessor and electromagnet electrically inter-connected in feed back loop as to minimize the emission of carbon monoxide and unburned hydrocarbons while maximizing the output of carbon dioxide. But Kita does not teach the use of permanent magnets nor any art of MHD generation or electrolysis to enhance the fuel.

Certain other patents known to the inventor are of interest only as background information, but are not believed to contain any teachings that are deemed relevant to the patentability of the present invention. These are U.S. Pat. No. 4,343,707 to Lucas dated Aug. 10, 1982 for a method and apparatus for separating out solids suspended in flowing, pure water systems such as those found in steam power plants, U.S. Pat. No. 4,381,463 to Branover issued Apr. 26, 1983 for a method and apparatus for producing electrical power and for the simultaneous heating of fluid, U.S. Pat. No. 4,663,548 to Kato issued May 5, 1987 for a MHD power generator, U.S. Pat. No. 4,716,024 to Pera issued Dec. 29, 1987 for magnetizing hydrocarbon fuels and other fluids, U.S. Pat. No. 5,487,370 to Miyazaki issued Jan. 30, 1996 which teaches fuel oil improvement apparatus, U.S. Pat. No. 5,816,226 to Jernigan, et al., issued Oct. 6, 1998 for an in-line fuel treatment device, U.S. Pat. No. 6,321,729 to Chien, dated Nov. 27, 2001 which teaches a method and apparatus for improving fuel, and U.S. Pat. No. 6,355,166 to Amarasinghe, et al., issued Mar. 12, 2002 for magnetically enhanced composite materials and methods for making and using the same.

While many of these devices utilize magnetic fields to impart a change in the physical characteristics of the fuels such as reduce surface tension, or change of magnetic alignment of the fuel to increase combustion efficiency, none of the references use or suggest the use of the chemical composition of the fuel to maximum advantage.

All fuels in commercial use have not only the hydrocarbon content of the fuel present but also contain additives and water. All of these molecules are subject to be decomposed into smaller molecular entities, including gases, under the influence of an electric field. This process is commonly known as electrolysis. By way of example, two primary gases generated by the electrolysis of water are hydrogen and oxygen. It is widely known that these two gases when dissolved or suspended in a hydrocarbon fuel and burned in either an open or closed combustion system will increase the combustion efficiency and thereby reduce the rate of toxic exhaust emissions. By the addition of these gases the cetane and octane level of the fuel is increased.

The problem, prior to this invention, has been the addition of the gases to the fuel in a safe and effective way that will be suitable for the incorporation into both mobile and stationary fueled devices. Limited as to storage, control and crash safety have been other concerns that reduced the use of compressed gases as additives to fuel in vehicular applications. The one common exception is in certain types of auto racing where special gas injection is allowed to boost performance.

The invention solves the foregoing problem in a new and innovative fashion by utilizing the energy of the flowing fluid to generate an electrical current using a MHD generator to produce the electrical energy needed for the subsequent electrolysis of the fuel. The gases generated by this process remain dissolved and/or suspended in the fuel and are carried directly to the point of combustion.

During combustion the suspended gases aid in and contribute to the increased efficiency of the combustion process and reduction in toxic gas emissions.

Another aspect of this invention is that the process can be controlled by a microprocessor that is activated by feedback loop circuitry based on the energy requirements of the combustion device. This allows for the control of the electrolysis process which in turn controls the burning efficiency and exhaust emissions characteristics.

An additional aspect of this invention is that the electricity produced may be in excess of what is required to maintain the electrolysis and can thus be used for other means such that would be typical of any electric generator.

The gasification of a hydrocarbon fuel while in the magnetic state will also offer other benefits to the fuel such as a reduction of microbiological growth and reduced scaling. The same is true for other fluids such as water.

All of the preceding benefits are a result of a new and innovative method of treating a magnetizable fluid with a self-powered magnetohydrodynamic EMF generator and using the output of the generator to electrolyze the fluid to produce gases that contribute to the combustibility of the fluid and reduce certain deleterious side effects that occur to such fluids in practical use.

The advantage over the present art is that the device and method described are more energy efficient, cost effective and independent of external energy sources. The method of using a magnetohydrodynamically generated EMF current from the magnetization of the fluid flowing through a device to convert the kinetic energy of the flow into the potential energy of the EMF which is then converted into a chemical energy through the process of electrolysis has not been taught or suggested by the prior art. The net advantage in the use of this method and device is the more complete combustion of hydrocarbon fuels with a resultant decrease in toxic emissions. Additionally, the method and process are an energy recovery technology, because the EMF current may be produced in larger quantity than is needed for optimal hydrolysis.

Bearing in mind the foregoing, it is a principal object of the present invention is to impart improved performance characteristics to any hydrocarbon fuel and to produce in any fluid a magnetic moment and an electrolytic induced improvement in the flow and surface tension parameter of the said fluid.

Another principal object of the present invention is to utilize energy of flowing hydrocarbon fuel in an internal combustion engine or external combustion system to generate an electrical current using a MHD generator to produce electrical energy used for subsequent electrolysis of the fuel.

It is a related principal object of the present invention to use the chemical composition of the fuel to maximum advantage.

A significant object of the invention is to reduce dangerous or toxic exhaust emissions in the burning of hydrocarbon fuels.

A related significant object of the invention is facilitate the electrolysis of hydrocarbon fuel in close proximity to its combustion to dissolve and/or suspend hydrogen and oxygen in the fuel to reduce dangerous or toxic exhaust emissions at combustion of the fuel while at the same time increasing the cetane and octane level of the fuel just before combustion because of the gases presence to increase its combustion efficiency.

A further object of the invention is the addition of gases to hydrocarbon fuel in a safe and effective way that will be suitable for the incorporation into both mobile and stationary fueled devices.

Another object of the invention is avoid storage, control and crash safety concerns in the use of compressed gases as additives to fuel, particularly in vehicular applications.

An additional object of the invention is to utilize the energy of flowing hydrocarbon fuel to generate an electrical current using a MHD generator to produce the electrical energy for subsequent electrolysis of the fuel wherein the gases generated by this process remain dissolved and/or suspended in the fuel and are carried directly to the point of combustion to increase its efficiency.

A further object of the invention is to control the foregoing system by a microprocessor that is activated by feedback loop circuitry based on the energy requirements of the combustion device, thus allowing for the control of the electrolysis process which, in turn, controls the burning efficiency and exhaust emissions characteristics.

Another object of the invention is that the electricity produced may be in excess of what is required to maintain optimal electrolysis and can thus be used for other means such that would be typical of any electric generator.

One more object of the invention is that gasification of hydrocarbon fuel while in the magnetic state offers other benefits to the fuel such as reduction of microbiological growth and reduced scaling.

One additional object of the invention is the use of the same combination of magnetic treatment of a fluid, generation of an EMF current, and the use of the EMF current to cause electrolysis can be used with fluids other than hydrocarbon fuels, such as water, to reduce bio fouling and scaling because the magnetic treatment causes reduction in scaling, and the formation of gases by electrolysis, at least the oxygen, reduces the biological load of the fluid.

The present invention accomplishes the above stated objectives, as well as others, as may be determined by a fair reading and interpretation of the entire specification and claims. Various other objects, advantages, and features of the invention will become apparent to those skilled in the art from the following descriptions taken in conjunction with the appended drawings.

### SUMMARY OF THE INVENTION

The present invention accomplishes the above-stated objectives, as well as others, as may be determined by a fair reading and interpretation of the entire specification.

In accordance with the principal aspect of the present invention, there is provided a method for producing electrical power by means of a magnetohydrodynamnic (MHD) generator, using the electrical power produced to electrolyze a fluid, and incorporating the electrolyzed fluid gaseous products into the fluid. The apparatus includes a chamber through which the fluid passes in a laminar flow that contains a series of high energy magnets in direct contact with the fluid such that the fluid has imparted to it a magnetic moment. The magnetized fluid induces an electric current to flow using an induction coil in contact with the fluid stream. The generated electric current is then preferably conditioned by a microprocessor and returned to the fluid stream via a pair of electrodes placed in direct contact with the fluid. DC electric power applied to the electrodes generates gases thereat, oxygen at the cathode and hydrogen at the anode. In mechanisms having such capabilities, such as modern vehicular engines, the microprocessor may be interconnected with a computer interface module to facilate communications between the inventive system and the “on board” diagnostic engine computer to optimize operation of the inventive system.

Various other objects, advantages, and features of the invention will become apparent to those skilled in the art from the following discussion taken in conjunction with the following drawings, in which:

### BRIEF DESCRIPTION OF THE DRAWINGS

FIG. 1 is a lateral section through the inventive device showing the major components in block format. This figure shows the relationship to the various major operational sections; i.e. the laminar flow baffles, flow sensor, magnetizing array, induction pickup coil, electrodes and exit tube.

FIG. 2 is block diagram showing the interrelationship to the major electrical components and how they are interconnected.

FIG. 3 is a flow diagram and logic pathway for the device.

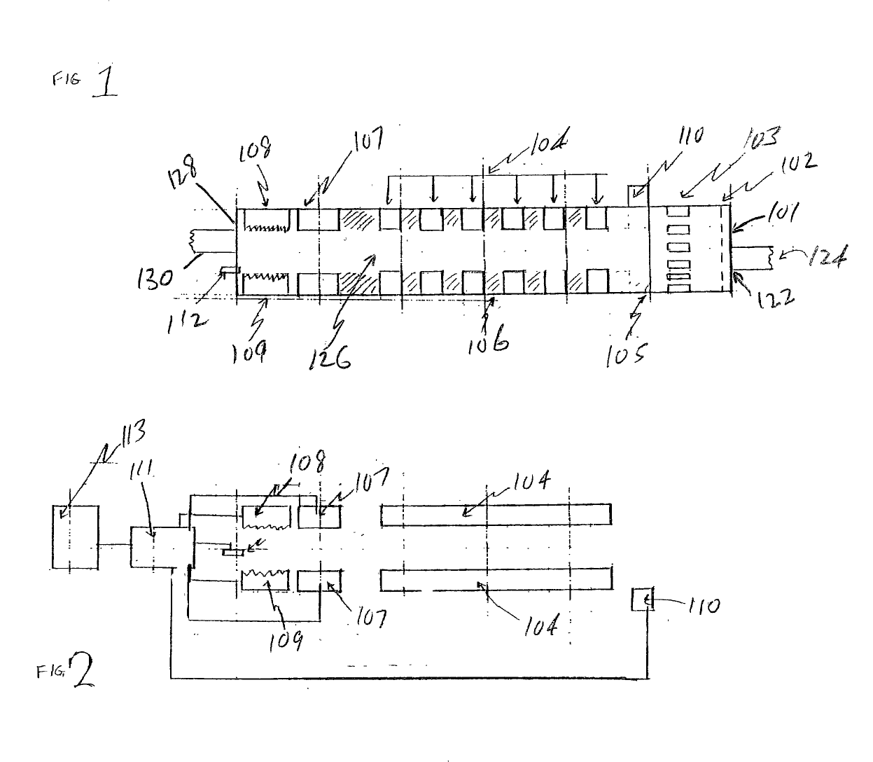

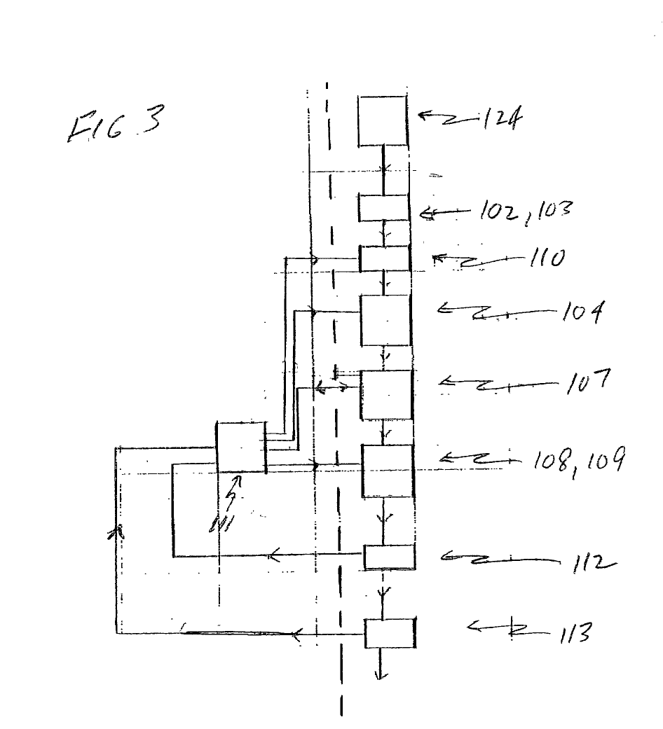

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various figures are designated by the same reference numerals.

The present invention comprises a method and apparatus to be employed in line with a fluid transport line. The fluid transport line may be a fuel line to an internal combustion engine, a fuel line to a furnace, a fuel line to a jet engine, or a line through which is transported other fluids such as water. The essential principles of the inventive apparatus and method are substantially the same regardless of whether the fluid being treated is a hydrocarbon fuel or another fluid such as one containing water.

The method contemplates producing electrical power by means of a magnetohydrodynamnic (MHD) generator, using the electrical power produced to electrolyze a fluid, and incorporating the electrolyzed fluid gaseous products into the fluid. The apparatus for doing so includes a chamber disposed within a housing through which the fluid passes in a laminar flow that contains an array of high energy magnets in direct contact with the fluid such that the fluid has imparted to it a magnetic moment. The magnetized fluid induces an electric current to flow using an induction coil disposed about, but external to, the fluid stream. The generated electric current is then preferably conditioned by a microprocessor and returned to the fluid stream via a pair of electrodes placed in direct contact with the fluid. DC electric power applied to the electrodes generates gases thereat, oxygen at the cathode and hydrogen at the anode. In mechanisms having such capabilities, such as modern vehicular engines, the microprocessor may be interconnected with a computer interface module to facilate communications between the inventive system and the “on board” diagnostic engine computer to optimize operation of the inventive system.

The apparatus includes a housing 105 constructed from nonconducting material that is resistant to hydrocarbon fluid. It is preferably a cylinder fabricated from lexan™ (presently available from General Electric Co.) The housing 105 has an opening 120 in the housing 105 upstream end 101 to which is attached a fitting 122 consisting of a barbed or threaded end which attaches to the fluid line 124 and is sized according to the flow rate of the device and the dimensions of the fluid line 124.

Disposed within the housing 105 and immediately downstream of the upstream end 101 is a filter screen 102 to remove particulate debris, made out of a fluid resistant material preferably such as bronze or stainless steel and preferably with a nominal mesh size of 80 (bronze wire cloth, such as presently available from E. P. Smith Wire Cloth Co. Franklin Park, Ill.).

Moving downstream inside the housing 105 are laminar flow vanes (louvers) 103 over which the fluid flows. The vanes induce a laminar flow to the fluid and reduce the turbulence of the flow so as to allow for a more effective magnetization thereafter in the housing 105. The vanes are preferably constructed from bronzes and use the NASA laminar flow design configuration known to those skilled in the art. It should be noted that it is necessary to allow sufficient space between the filter screen 102 and the laminar flow louvers 103 to reduce any turbulence from the filter screen 102 and prevent reflectance waves from forming in the fluid stream. The louvers act as a laminar flow control device to create a smooth and homogenous flow into the magnetizing area of the device.

Next downstream is a flow sensor 110 to read the flow volume and rate as part of the feedback loop of the control circuit. The flow sensor 110 (such as presently available from Cole Palmer, Vernon Hills, Ill.) is not disposed within the housing but mounted to the outside surface and senses the flow through standard ultrasonic measurement methods.

Continuing downstream and disposed within the chamber 126 of housing 105 is magnetic array 104, which is placed within the fluid stream, and the fluid is in direct contact with the magnetizing elements. The magnets are preferably permanent magnets, but electromagnets are an alternative embodiments. The individual magnets are preferably made of rare earth high gauss materials that have a very high magnetic flux density (such as are presently available from Dexter Magnetic Technologies, Inc., Fremont, Calif.).

The polarity of the magnets is arranged so as to provide the highest degree of magnetization. That means in this configuration to have all north poles 180 degrees apart from all south poles with the top array being north and the bottom array being south. No more that two total n-s arrays are provided for use in a linear housing. Thus each array is offset by 90 degrees to the corresponding array. All magnets in any given array are aligned with the similar polarity (e.g., all north) facing the same direction. In some applications the magnetic fields of all the arrays may be of the same polarity (i.e., all North or all South).

The spaces between the individual magnets and the arrays are filled with a suitable material resistant to hydrocarbon fluid called spacers 106. Spacers 106 are preferably fabricated from an epoxy (such as Devcon™) that acts to keep the magnets in alignment as well as the fluid interface smooth. The filler prevents “dead” spots in the flow and retains the laminar nature of the flow. The number of magnets in the array will depend on the diameter of the housing and the flow velocity and can be adjusted for surface area by those skilled in the arts, so as to optimize the surface contact area.

Placed next downstream of the magnets, is an induction coil/pickup 107. The coil (such as presently available from Allied Electronics, Inc., Ft. Worth, Tex.) is a standard toroidal high turn fine wire wound coil familiar to those skilled in the arts and capable of field induction from the level of magnetic energy present in the fluid stream. The coil is similarly imbedded in the filler/spacers material 106 so as to provide a smooth interface with the fluid flow and to be rendered impervious to the fluid.

Thereafter proceeding downstream are disposed an anode electrode 108 and a cathode electrode 109. These are comprised of a plated grid (gold or silver or platinum) with an individual surface area five times the surface area of the magnetic array monopole. This is a screen grid formed to a support backing and attached to the housing 105 with a nonconductive adhesive. The grid electrode is mounted flush with the other inline components so as to retain the laminar flow characteristics of the fluid. Electrical leads attached to the electrodes 108, 109 are brought through the housing and lead to a microprocessor 111 which may be attached to the housing or not as dictated by the mounting location and installation requirements.

Microprocessor controller 111(such as presently available from Allied Electronics, Ft. Worth, Tex.) is a programmable device which inputs the EMF generated from the induction coil 107 and controls the output to the electrodes 108, 109 as dictated by pre-programmed parameters of the end use device (e.g., internal combustion engine, furnace, etc.) that are integrated into the controller through such things as the flow sensor 110 and other components described hereinafter.

The apparatus is further provided with a gas sensor 112 (such as presently available from Gas Tech, Newark, Calif.), which is mounted in the downstream end 128 of the housing 105 and flush with the fluid flow. The gases that are detected can be oxygen or hydrogen or may be others as dictated by the starting nature of the fluid used. The output of the gas sensor 112 is fed to the microprocessor 111 to be used in the regulation of the electrode grid function.

External device computer interface module 113 is an “on board” diagnostic computer found on all new engines. This interface signal is fed to the microprocessor 111 which is able to use the external sensor information to help control the output of the inventive treatment device to meet the varying combustion demands of the engine. This allows for the better control of the toxic emissions and for increased fuel economy.

At the end of the housing 105 is the outlet pipe 130 into which is placed a static spiral mixing vane (not shown) of conventional design that assures the complete dispersion of the generated gases into the fluid stream. The outlet pipe is so designed as to allow for the simple attachment to the fluid line as close as practical to the point of combustion.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. An apparatus for treating a flowing fluid comprising:
a housing in fluid communication with a fluid line;
at least one magnet disposed within the housing in magnetic communication with flowing fluid from the fluid line to magnetize the fluid;
an induction coil disposed downstream of the at least one magnet and in magnetic communication with the flowing fluid; and
electrodes in electrical communication with the induction coil and the flowing fluid to cause electrolysis in the flowing fluid.

2. The apparatus of claim 1 in which the at least one magnet further comprises a magnetic array.

3. The apparatus of claim 2 in which the magnetic array further comprises spacers interspersed with magnets.

4. The apparatus of claim 2 which further comprised a filter in fluid communication with the flowing fluid and disposed upstream of the magnetic array.

5. The apparatus of claim 2 which further comprises laminar flow vanes in fluid communication with the flowing fluid and disposed upstream of the magnetic array.

6. The apparatus of claim 1 which further comprises a flow sensor in sensory communication with the flowing fluid.

7. The apparatus of claim 1 which further comprises a gas sensor in sensory communication with the flowing fluid downstream of the electrodes.

8. The apparatus of claim 1 which further comprises a microprocessor in electrical communication with the electrodes to control output to the electrodes from the induction coil.

9. The apparatus of claim 8 in which the microprocessor is further in electrical communication with a flow sensor and a gas sensor to determine how to control the output to the electrodes from the induction coil.

10. The apparatus of claim 8 in which the microprocessor is further in electrical communication with an external device computer interface module to optimize operation of the apparatus in conjunction with needs of an external device in which the fluid line is disposed.

11. The apparatus of claim 1 where the flowing fluid is a hydrocarbon fuel, and the treatment increases combustion efficiency and decreases toxic emissions.

12. A method for treating a flowing fluid comprising:
producing electrical power by means of a magnetohydrodynamic generator; and
using the electrical power produced to electrolyze the flowing fluid leaving electrolyzed fluid gaseous products in the flowing fluid.

13. The method of claim 12 in which magnetohydrodynamic generator further comprises:
magnetizing the flowing fluid; and
exposing the magnetized flowing fluid to an induction coil to generate an EMF current.

14. The method of claim 12 which further comprises filtering the flowing fluid before magnetizing it.

15. The method of claim 12 which further comprises exposing the flowing fluid to laminar flow vanes before magnetizing it.

16. The method of claim 12 which further comprises controlling electrolyzing using a microprocessor.

17. The method of claim 16 which further comprises electrically connecting the microprocessor to a flow sensor and a gas sensor for input information and to electrolyzing means to control electrolyzing.

18. The method of claim 17 which further comprises electrically connecting the microprocessor to an external device computer interface module to optimize operation of the method in conjunction with needs of an external device in which the flowing fluid is employed.

19. The method of claim 12 where the flowing fluid is a hydrocarbon fuel, and the treatment increases combustion efficiency and decreases toxic emissions.
